(19) United States
(12) Patent Application Publication
(10) Pub. No.: US 2016/0265712 A1
(43) Pub. Date: Sep. 15, 2016

(54) Method and apparatus of a versatile multiple-purpose stand

(71) Applicants: Haw-Renn Chen, Moorpark, CA (US); Feichu H. Chen, Moorpark, CA (US)

(72) Inventors: Haw-Renn Chen, Moorpark, CA (US); Feichu H. Chen, Moorpark, CA (US)

(21) Appl. No.: 14/544,898

(22) Filed: Mar. 3, 2015

(51) Int. Cl. F16M 11/24; H04R 1/08; A47B 19/00; F16M 11/40; F16B 1/00

(52) U.S. Cl. CPC F16M 11/24; F16M 11/40; F16B 1/00; A47B 19/002; H04R 1/08; F16B 2001/0035

(57) ABSTRACT

A method and apparatus of a versatile multiple-purpose stand with the configuration of a means for holding, a connection means, and a means for supporting, where the means for holding is connected to the means for supporting through the connection means which comprises various connecting mechanism including an one-hand operation mechanism with a means for control to adjust the height of the stand just by one hand, a flexible column connection mechanism having a flexible column as a connection means such that the height of the stand is adjusted by the degree that the flexible column is bent, or a connection mechanism provided by the attractive force generated by a magnetic field and the material generating attractive force in a magnetic field, such as a metal body, such that the means for holding can be connected to any area or space that includes the material generating attractive force and a magnetic field.

### BACKGROUND OF THE INVENTION

There are a variety of stands for many different applications. The popular stands in the music and sound industries include guitar stands, speaker stands, music stands, and microphone stands. The sturdiness and easiness of use have been the major focus in the stand product development. A stand to perform a variety of functions and to be easy-to-use is still not popular in the current market. Most of the stands are configured to have a single application. With the considerations of economy and the conservation of material to be environmental friendly, a stand configured to be user friendly and to perform multiple functions is highly desirable.

The invention relates in general to a method and apparatus of a versatile stand which is configured not only to be easy to operate but also to be versatile to perform multiple functions in various stand applications.

### Objects and Advantages of the Invention

Accordingly, the present invention is to introduce a method and apparatus for a versatile stand configuration that can be used as a desk-top music stand, a microphone stand, and a floor music stand.

In addition, the present invention is intended to provide the users the conveniences of adjusting the height of the stand conveniently by one-hand, utilizing the stand in a variety of applications, and having versatile magnet attachment mechanism. Besides conveniences, this present invention, when utilized in the variety of applications, will be stable and long lasting.

The one-hand-operation mechanism includes utilization of a one-hand operation control clutch and a flexible column, such as a gooseneck. Furthermore, the novel magnet plate design enables the users to attach and detach various product holders or containers to and from any base easily.

As a result, the advantages and primary object of the present invention are to provide a flexible, versatile, sturdy, and easy-to use versatile stand by incorporating the one-hand-operation, flexible connection mechanism, and magnet feature to a base or a stand. Particularly with the magnet attachment feature, the present invention provides an economic, long-lasting and environment-friendly stand that allows the users to use in various ways.

### BRIEF DESCRIPTION OF THE DRAWINGS

FIG. 1 illustrates the detail configuration of the side view of the one-hand-operation stand.

FIG. 1A illustrates the detail configuration of the front view of the top plate.

FIG. 1B illustrates the detail configuration of the front view of the removable side hanging means.

FIG. 1C illustrates the detail configuration of the top view of the removable side hanging means.

FIG. 1D illustrates the detail configuration of the side view of a top plate being used as a desktop music stand.

FIG. 2 illustrates the detail configuration of the one-hand-operation control mechanism.

FIG. 3 illustrates the detail configuration of the connection adapting means.

FIG. 3A illustrates how the connection adapting means can be used to convert a regular microphone stand into a sheet music stand by inserting the connection adapting means onto a regular microphone stand.

FIG. 3B illustrates that the one-hand-operation stand is utilized as a microphone stand.

FIG. 4 illustrates the detail configuration of the side view of a one-hand-operation stand with a gooseneck.

FIG. 4A illustrates the detail configuration of how the height adjustment means is connected to the support column.

FIG. 4B illustrates the higher position of the height adjustment means of the one-hand-operation stand with a gooseneck.

FIG. 4C illustrates the lower position of the height adjustment means of the one-hand-operation stand with a gooseneck.

FIG. 5 illustrates the detail configuration of a sheet music stand with a magnet mounted on the magnet mounting plate and connected to the tilt-angle adjustment mechanism.

FIG. 5A illustrates the detail configuration of the connection guides on the top plate.

FIG. 6 illustrates the detail configuration of a sheet music stand with a magnet on the top plate.

FIG. 6A illustrates the detail configuration of the connection guides on a mounting guide plate.

FIG. 7 illustrates that a means for holding with a magnet is to be connected to a metal body mounted on a surface.

FIG. 7A illustrates that a means for holding with a magnet is connected to a metal body mounted on a surface.

FIG. 8 illustrates that a means for holding with a magnet is to be connected to a metal body implanted in a surface.

FIG. 8A illustrates that a means for holding with a magnet is connected to a metal body implanted in a surface.

FIG. 9 illustrates that a means for holding made of metal is to be connected to a body with magnets and the body is mounted to a surface.

FIG. 9A illustrates that a means for holding made of metal is connected to a body with magnets and the body is mounted to a surface.

FIG. 10 illustrates that a means for holding made of metal is to be connected to a body with magnets and the body is implanted in a surface.

FIG. 10A illustrates that a means for holding made of metal is connected to a body with magnets and the body is implanted in a surface.

FIG. 11 illustrates the detail configuration of a base which comprises three horizontally extended legs with caps at each end of the legs.

### DETAIL DESCRIPTION OF THE METHOD AND EMBODIMENT SUMMARY, RAMIFICATIONS, AND SCOPE

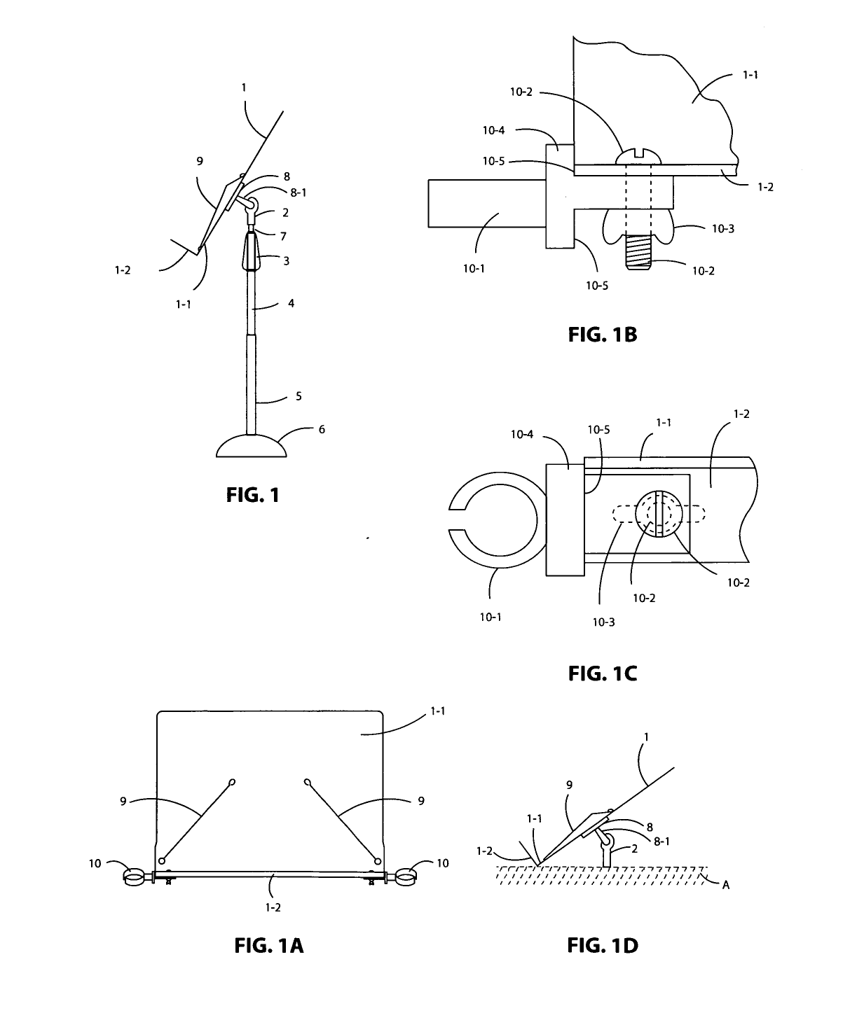

An one-hand operation stand used as a sheet-music stand is illustrated in FIG. 1 in which numeral 1 illustrates the side view of the top plate or the first means for holding which is used to hold the sheet music or any article, including a tablet device, numeral 2 illustrates the adaptable connecting means that is used to connect the first means for holding to an upper support column or the third means for supporting, as indicated by numeral 4, and allow the tilt angle of the top plate to be adjusted, numeral 3 illustrates the one-hand-operation control clutch or the fourth means for control which is located at the top portion of the upper support column or the third means for supporting, 4, numeral 5 illustrates the lower supporting column or the fifth means for supporting, numeral 6 illustrates the foundation base, numeral 7 illustrates the connection adapting means, numeral 8 and numeral 8-1 illustrate the fastening means which are to fasten one end of the adaptable connection means, 2, to the top plate or the first means for holding, 1, numeral 9 illustrates the sixth means for securing which is used to secure music sheets or an electronic device onto the top-plate, 1. The top plate or first means for holding, 1, comprises a top-plate body as illustrated by numeral 1-1 and a top-plate support base as illustrated by numeral 1-2 which is the support base for an electronic device or music sheets to sit on. The adaptive connecting means, 2, the connection adapting means, 7, and the fastening means, 8 and 8-1, function collectively as the second means for connecting. As illustrated in FIG. 1, the top-plat support base, 1-2, is typically made as an extension of the top plate body, 1-1, and is bent to have roughly a 90 degree angle with the top-plate body, 1-1.

FIG. 1A shows the front view of the top plate or first means for holding, 1, which includes the top-plate body, 1-1, the top-plate support base, 1-2, the sixth means for securing, 9, configured as two clips typically made of bent thin metal sticks, and numeral 10 which illustrates a removable side hanging means or the seventh means for hanging configured at one side or both sides of the top-plate support base, 1-2, to hang various objects such as microphones, earphones, violin bows, etc. The front view and the top view of the detail configurations of the removable side hanging means, 10, are illustrated in FIG. 1B and FIG. 1C respectively. In FIGS. 1B and 1C, the removable side hanging means, 10, further comprises the hanging ears, 10-1, the fastening bolt, 10-2, the butterfly nut, 10-3, and the positioning block, 10-4. The removable side hanging means, 10, can be removed from the top-plate support base, 1-2, by having the butterfly nut, 10-3, loosened and removed from the fastening bolt, 10-2. The positioning block, 10-4, is used to fix the entire removable side hanging means, 10, at a predetermined position by aligning the inner edge, 10-5, of the positioning block, 10-4, to the edge of the top-plate support base, 1-2.

FIG. 1D illustrates the detail configuration of the side view of the top plate or the first means for holding, as illustrated by numeral 1 in FIG. 1, being used as a desktop music stand. The adaptable connection means, as illustrated by numeral 2 in FIG. 1, is configured to have a length such that the base of the adaptable connection means, 2, and the base of the top-plate support base as illustrated by numeral 1-2 in FIG. 1 form a triangle base for the top plate, 1, to be securely placed on a flat surface A, such as a desktop surface.

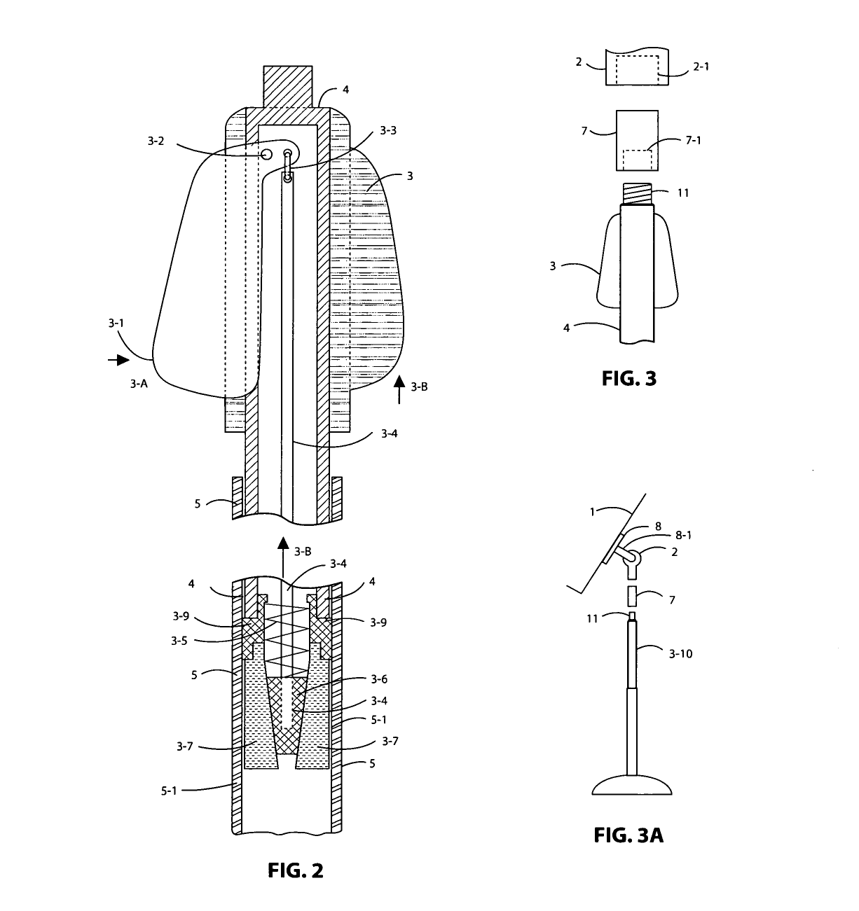

FIG. 2 illustrates the detail internal configurations of the one-hand-operation control mechanism configured in the fourth means for control, 3, the upper supporting means or the third means for supporting, 4, and the lower supporting means or fifth means for supporting, 5, where the control mechanism either allows or stops the upper supporting means, 4, to slide along and inside the lower supporting means, 5, by means of the fourth means for control, 3. The control mechanism comprises a lever, 3-1, a fastening point, 3-2, a control point, 3-3, a control column, 3-4, a compressed spring, 3-5, a control conical taper, 3-6, and a cylindrical expansion block, 3-7. The fastening point, 3-2, is secured to the wall of the upper supporting means, 4. The lever, 3-1, is located a distance away from the fastening point, 3-2. The control point, 3-3, is located at the other side of the fastening point, 3-2, from the lever, 3-1. The upper end of the control column, 3-4, is fastened to the control point 3-3. The control column, 3-4, extends from the control point, 3-3, through the compressed-spring stop, 3-9, to the conical control taper, 3-6. The lower end of the control column, 3-4, is fastened to the conical control taper, 3-6. The cylindrical expansion block, 3-7, is a flexible expandable cylindrical solid and is positioned around the conical control taper, 3-6, and is securely fastened to the lower part of the compressed-spring stop, 3-9. The compressed spring, 3-5, is compressed between the compressed-spring stop, 3-9, and the conical control taper, 3-6. The compressed spring, 3-5, pushes the conical control taper, 3-6, with a downward force and, as a result, the conical control taper, 3-6, applies to the cylindrical expansion block, 3-7, a radially outward force to try to expand the cylindrical expansion block, 3-7. Since the cylindrical expansion block, 3-7, is confined in the inside wall, 5-1, of the lower supporting means, 5, the radially outward force from the conical control taper, 3-6, compresses the volume of the cylindrical expansion block, 3-7, between the conical control taper, 3-6, and the inside wall, 5-1. The compressed volume of the cylindrical expansion block, 3-7, tries to expand toward the inside wall, 5-1, and, hence, creates a resistance force between the cylindrical expansion block, 3-7, and the inside wall, 5-1, of the lower supporting means, 5. The resistance force between the cylindrical expansion block, 3-7, and the inside wall, 5-1, of the lower supporting means, 5, stops the cylindrical expansion block, 3-7, and, as a result, the upper supporting means, 4, from moving along the inside wall, 5-1, of the lower supporting means, 5, and, therefore, the height of the stand is fixed.

As shown in FIG. 2, when an inward force is applied to the level, 3-1, at the position and with the direction as indicated by 3-A, the control point, 3-3, will move to the upward direction, as indicated by 3-B, as the lever, 3-1, is located at the opposite side of the fastening point, 3-2, from the control point 3-3. Since the compressed spring, 3-5, can not move in the direction of 3-B due to the position restricted by the compressed-spring stop, 3-9, the control column, 3-4, is forced to compress the compressed spring, 3-5, further when it is forced to move in the direction of 3-B. As the control column, 3-4, moves in the direction of 3-B, the conical control taper, 3-6, moves upwards accordingly. As the conical control taper, 3-6, is raised upwards, the radially outward force applied to the cylindrical expansion block, 3-7, is reduced due to the compressed volume of the cylindrical expansion block, 3-7, compressed by the conical control taper, 3-6, is reduced. Hence, the resistance force between the cylindrical expansion block, 3-7, and the inside wall, 5-1, of the lower supporting means, 5, is reduced or removed. Once the resistance force between the cylindrical expansion block, 3-7, and the inside wall, 5-1, of the lower supporting means, 5, is reduced or removed, the upper supporting means, 4, is allowed to move along the inside wall, 5-1, of the lower supporting means, 5, and hence the height of the stand is adjustable at that time.

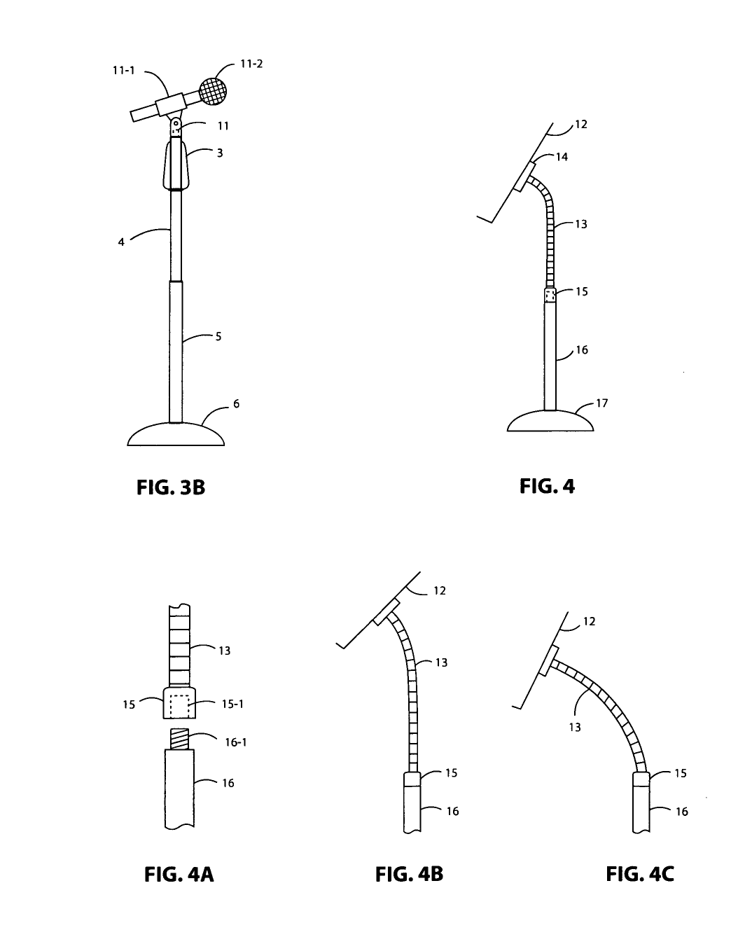

The detail configuration of the connection adapting means, as indicated by numeral 7 in FIG. 1, is illustrated in FIG. 3 in which numeral 2 illustrates the lower portion of the adaptable connection means as shown in FIG. 1, numeral 4 illustrates the top portion of the upper supporting means, numeral 3 illustrates the fourth means for control in FIG. 1. The top portion of the upper supporting means, 4, is configured with an outer threaded section, 11, for fitting a microphone holder or a microphone stand boom. An inner threaded portion made at one hollow end of the connection adapting means, 7, is illustrated as numeral 7-1. These inner threads on numeral 7-1 are made to match the outer threads on numeral 11 so that the connection adapting means, 7, can be inserted to fit onto the outer threaded section, 11. An adaptable connection means, numeral 2 in FIG. 1, with an inner hollowed section, 2-1, can be inserted onto the top of the connection adapting means, 7, by aligning the inner hollowed section, 2-1, to the periphery of the top section of the connection adapting means, 7, and having the top section of the connection adapting means, 7, inserted into the inner hollowed section, 2-1.

Since the top portion of the upper supporting means, 4, is configured with an outer threaded section, 11, for fitting a microphone holder or a microphone stand boom and the inner threads on numeral 7-1 are made to match the outer threads on numeral 11, as shown in FIG. 3, the connection adapting means, 7, can be used to convert a microphone stand into a sheet music stand by inserting the connection adapting means, 7, onto a regular microphone stand as depicted in FIG. 3A, where numeral 1 is a top plate, numeral 2 is the adaptable connection means, numeral 7 is the connection adapting means, numerals 8 and 8-1 are the fastening means, and numeral 3-10 is a regular microphone stand.

As depicted above and in FIGS. 1 and 3, the combination of the outer threaded section, 11, the fourth means for control, 3, the upper supporting means, 4, the lower supporting means, 5, and the foundation base, 6, can be used as an one-hand-operation microphone stand by replacing the connection adapting means, 7, with a microphone holder or a microphone-stand boom to the outer threaded section as shown in FIG. 3B, where numeral 3 is the fourth means for control, numeral 11-1 represents a microphone holder inserted onto the outer threaded section, 11, and numeral 11-2 represents a microphone held by the microphone holder 11-1.

A sheet music stand with a gooseneck, or any flexible semi-rigid material, is illustrated in FIG. 4 in which numeral 12 illustrates the top plate or the eighth means for holding which is used to hold the sheet music or any article, including a tablet device, numeral 13 illustrates the height and orientation adjustment means or the ninth means for adjusting which is configured with a long gooseneck or a long column of flexible semi-rigid material, numeral 14 illustrates the fastening means which is to fasten one end of the ninth means for adjusting, 13, to the eighth means for holding, 12. Numeral 15 illustrates the hollow end of the ninth means for adjusting 13, numeral 16 illustrates the support column or the tenth means for supporting and numeral 17 illustrates the foundation base.

FIG. 4A illustrates how the ninth means for adjusting, 13, is connected to the support column or the tenth means for supporting, 16. As illustrated in FIG. 4A, an outer threaded section as numeral 16-1 is configured at the top of the support column or the tenth means for supporting, 16, and an inner threaded portion as numeral 15-1 is configured at the hollow end, 15, of the ninth means for adjusting, 13. These inner threads on numeral 15-1 are made to match the outer threads on numeral 16-1 so that the ninth means for adjusting, 13, can be inserted to fit onto the support means or the tenth means for supporting, 16. The threads on both numeral 15-1 and numeral 16-1 are compatible with the standard microphone stand threads.

FIG. 4B illustrates that the eighth means for holding, 12, as illustrated in FIG. 4, can be adjusted to be higher simply by pressing it against the gooseneck or the height and orientation adjustment means, 13, to a higher position. FIG. 4C illustrates that the eighth means for holding, 12, can be adjusted to be lower simply by pressing it against the gooseneck or the height and orientation adjustment means, 13, to a lower position.

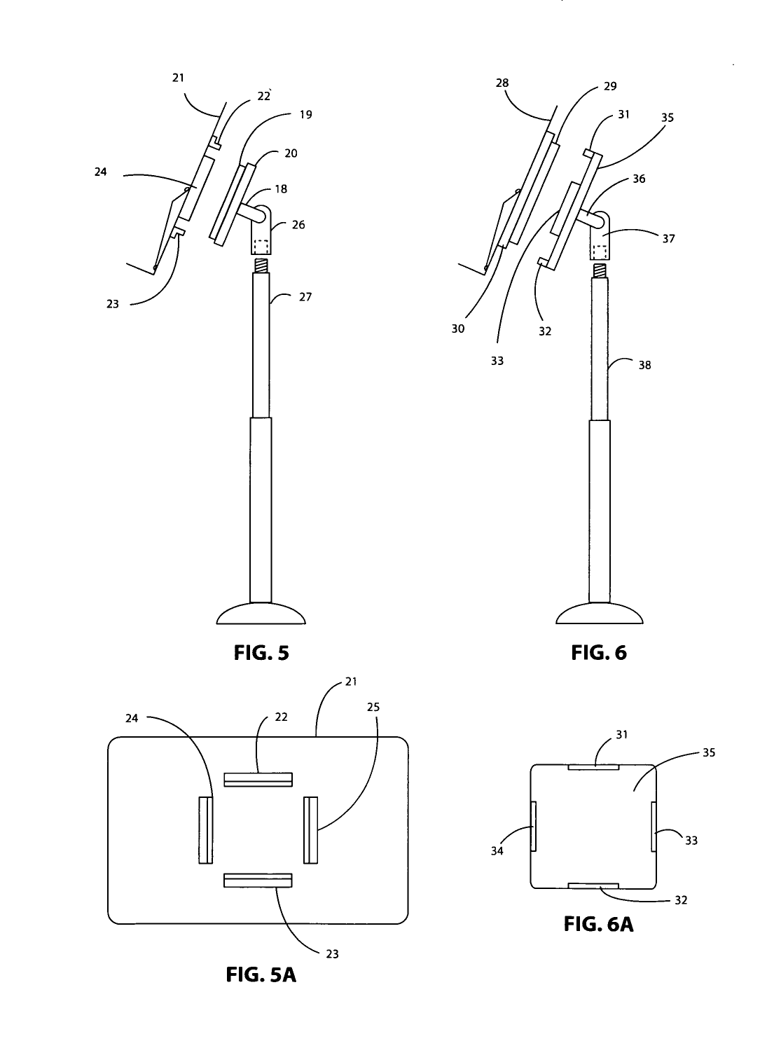

FIG. 5 illustrates the detail configuration of a sheet music stand with a magnet mounted on the magnet mounting plate and connected to the tilt-angle adjustment mechanism. FIG. 5A illustrates the detail configuration of the connection guides on the top plate. FIG. 5 and FIG. 5A illustrate a tilt-angle adjustment mechanism, 18, one or more magnet elements, 19, mounted onto a magnet holding plate, 20, the side view of the top plate, 21, the top mounting guide, 22, the bottom mounting guide, 23, the side mounting guides, 24 and 25, and an adaptable connection means, 26. The top plate, 21, which can be made of any material attractively reactive to a magnetic field is normally made of steel. When the magnet elements, 19, are mounted onto the back of the top plate, 21, with the mounting location defined by the mounting guides, numerals 22 through 25 as shown in FIG. 5A, and with the magnetic force from the magnet elements as the fastening means, the top plate, 21, is securely connected, through the tilt-angle adjustment mechanism, 18, to the adaptable connection means, 26, which is to be connected to any support means, 27. Since the magnet holding plate, 20, the tilt-angle adjustment mechanism, 18, the adaptable connection means, 26, and the support means, 27, constitute a stand base, the top plate, 21, or any means for holding including any material reactive to a magnetic field or steel can be securely connected or mounted to any stand base containing or installed with the magnet elements, 19.

FIG. 6 illustrates the detail configuration of a sheet music stand with magnet elements, 29, on the top plate, 28. FIG. 6A illustrates the detail configuration of the connection guides on the mounting guide plate, 35. FIG. 6 and FIG. 6A illustrate a tilt-angle adjustment mechanism, 36, one or more magnet elements, 29, mounted onto a magnet holding plate, 30, which is mounted on the top plate, 28. The top mounting guide, 31, the bottom mounting guide, 32, and the side mounting guides, 33 and 34, are on the mounting guide plate, 35, and are connected to the adaptable connection means, 37, through the tilt-angle adjustment mechanism, 36.

The top plate, 28, along with the magnet elements, 29, and the magnet holding plate, 30, can be connected to the adaptable connection means, 37, through the tilt-angle adjustment mechanism, 36, by mounting the magnet elements, 29, onto the mounting guide plate, 35, with the mounting location defined by the mounting guides, numerals 31 through 34 as shown in FIG. 6A, and with the magnetic force from the magnet elements, 29, as the fastening means. With the magnetic force from the magnet elements, 29, the top plate, 28, is securely connected, through the tilt-angle adjustment mechanism, 36, to the adaptable connection means, 37, which is to be connected to any support means 38. Since the mounting guide plate, 35, the tilt-angle adjustment mechanism, 36, the adaptable connection means, 37, and the desired support means, 38, constitute a stand base, the top plate, 28, or any means for holding with the magnet elements, 29, can be securely connected or mounted to any metal stand base.

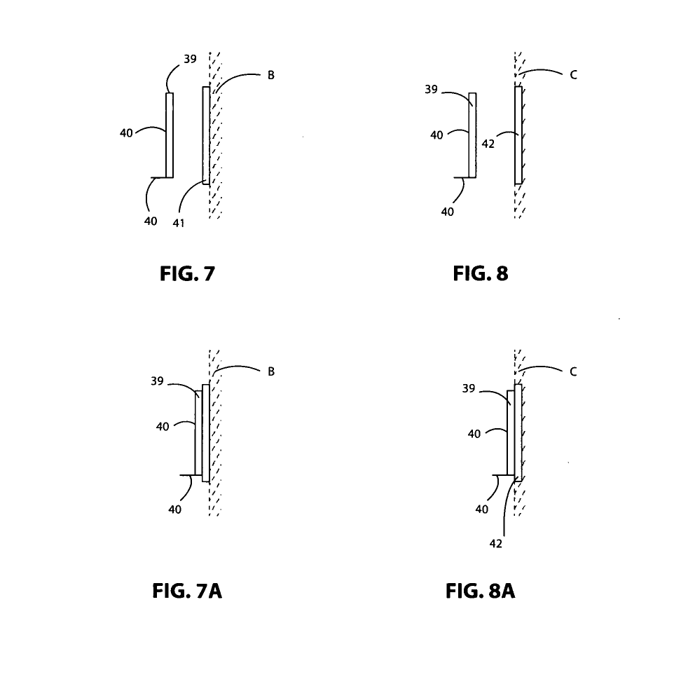

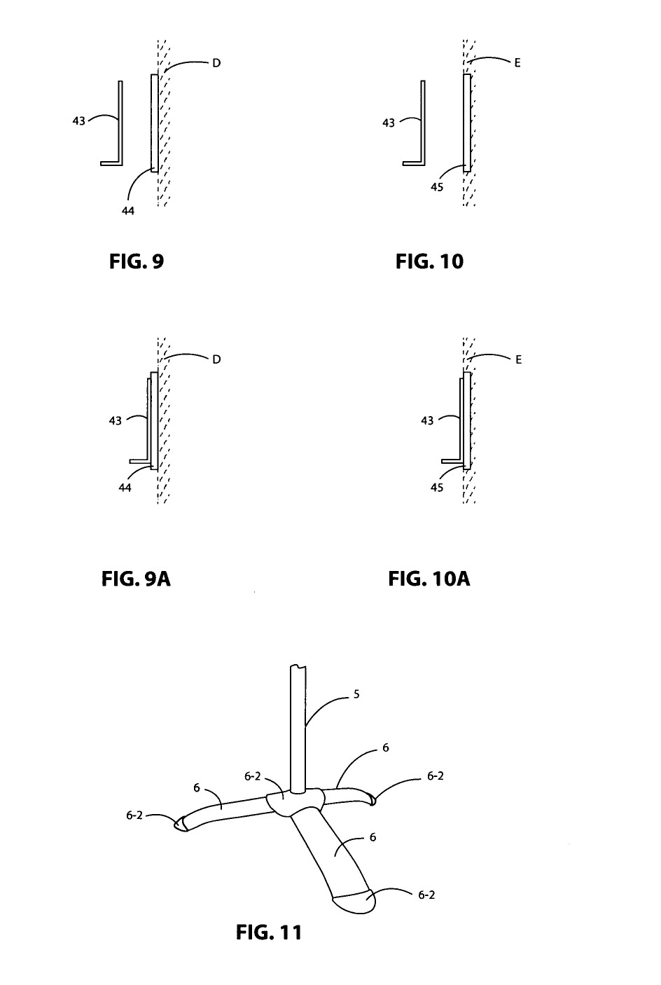

Based on FIG. 5, FIG. 5A, FIG. 6, and FIG. 6A, a method of utilizing magnetic force as the means to connect any means for holding with a means for providing magnetic field to predetermined areas or space while the predetermined areas or space either include an implanted material that can create an attractive magnetic force with a magnetic field or have a metal body that can create an attractive magnetic force with a magnetic field installed or mounted onto the surface are illustrated in FIG. 7, FIG. 7A, FIG. 8, and FIG. 8A. A method of utilizing magnetic force as the means to connect any means for holding including material that can create an attractive magnetic force with a magnetic field to predetermined areas or space while the predetermined areas or space either include an implanted means for providing magnetic field or have a means for providing magnetic field mounted or installed onto the surface are illustrated in FIG. 9, FIG. 9A, FIG. 10, and FIG. 10A.

FIG. 7 illustrates that the means for providing magnetic field, 39, is as a part of the eleventh means for holding, 40. The eleventh means for holding, 40, is to be connected to a predetermined body, 41, mounted on the surface B. The predetermined body, 41, includes a material that will generate or create an attractive magnetic force in a magnetic field. When the eleventh means for holding, 40, with the means for providing magnetic field, 39, are moved to be close to the predetermined boy, 41, the generated attractive magnetic force will push the eleventh means for holding, 40, with the means for providing magnetic field, 39, toward and to be connected to the predetermined body, 41. FIG. 7A illustrates that the eleventh means for holding, 40, with the means for providing magnetic field, 39, are connected to the predetermined body, 41.

FIG. 8 illustrates that the means for providing magnetic field, 39, is as a part of the eleventh means for holding, 40. The eleventh means for holding, 40, is to be connected to a predetermined body, 42, which is implanted in and as a part of surface C. The predetermined body, 42, includes a material that will generate or create an attractive magnetic force in a magnetic field. When the eleventh means for holding, 40, with the means for providing magnetic field, 39, are moved to be close to the predetermined boy, 42, the generated attractive magnetic force will push the eleventh means for holding, 40, with the means for providing magnetic field, 39, toward and to be connected to the predetermined body, 42. FIG. 8A illustrates that the eleventh means for holding, 40, with the means for providing magnetic field, 39, are connected to the predetermined body, 42.

FIG. 9 illustrates that the means for providing magnetic field is as a part of the predetermined body, 44, which is mounted on the surface D. The twelfth means for holding, 43, including a material that will generate or create an attractive magnetic force in a magnetic field, is to be connected to the predetermined body, 44. When the twelfth means for holding, 43, is moved to be close to the predetermined boy, 44, the generated attractive magnetic force will push the twelfth means for holding, 43, toward and to be connected to the predetermined body, 44. FIG. 9A illustrates that the twelfth means for holding, 43, is connected to the predetermined body, 44.

FIG. 10 illustrates that the means for providing magnetic field is as a part of the predetermined body, 45, which is implanted in and as a part of surface E. The twelfth means for holding, 43, including a material that will generate or create an attractive magnetic force in a magnetic field, is to be connected to the predetermined body, 45. When the twelfth means for holding, 43, is moved to be close to the predetermined body, 45, the generated attractive magnetic force will push the twelfth means for holding, 43, toward and to be connected to the predetermined body, 45. FIG. 10A illustrates that the twelfth means for holding, 43, is connected to the predetermined body, 45.

FIG. 11 illustrates an example of the detail configuration of the lower supporting column, 5, and the foundation base, 6, as those illustrates in the FIG. 1. As depicted in FIG. 11, the foundation base, 6, is configured to have three horizontally extended legs or bodies. These horizontally extended legs or bodies are connected to the lower supporting column through the connection means, 6-1. Each end of these horizontally extended legs or bodies is attached with a cap, as indicated 6-2. The cap, 6-2, is typically made of a softer material such as plastic material or rubberized material to protect the floor or the person who is carrying the stand with the foundation base, 6.

1. A versatile stand comprising
a first means for holding connected through a second means for connecting to a third means for supporting having a built-in fourth means for control, said third means for supporting inserted into a fifth means for supporting and said third means for supporting to be enabled to slide inside said fifth means for supporting by having said fourth means for control in a predetermined condition thereby height of said first means for holding connected to said third means for supporting through said second means for connecting to be adjusted by having said fourth means for control in said predetermined condition while said height of said first means for holding being to be forced to stay the same whenever said predetermined condition removed from said fourth means for control.

2. A versatile stand as set forth in claim 1 wherein said third means for supporting further including a threaded top end thereby said threaded top end is configured to hold a microphone holder or a microphone boom.

3. A versatile stand as set forth in claim 1 wherein said fifth means for supporting being fastened to a plurality of extended bodies with a cap attached to each extended body.

4. A versatile stand as set forth in claim 1 wherein said first means for holding includes the sixth means for securing.

5. A versatile stand as set forth in claim 1 wherein said first means for holding includes the seventh means for hanging.

6. A versatile stand as set forth in claim 1 wherein said first means for holding is configured to be separable from said third means for supporting and be placed on a surface with said first means for holding being utilized on said surface for holding any article or device.

7. A versatile stand comprising
an eighth means for holding connected through the ninth means for adjusting to the tenth means for supporting, said ninth means for adjusting configured as a column with flexible material thereby the axial contour of said column reshaped whenever pressure applied to said eighth means for holding such that said reshaped axial contour of said column allowing said eighth means for holding to stay at any desired location and orientation.

8. A versatile stand as set forth in claim 7 wherein said column with flexible material comprises a gooseneck.

9. A method of connecting a means for holding to a surface providing
a means for providing magnetic field
an eleventh means for holding
a predetermined body including material attractively reactive to magnetic field whereby said means for providing magnetic field included in said eleventh means for holding thereby said eleventh means for holding with said means for providing magnetic field to be securely connected to said predetermined body including material attractively reactive to magnetic field by means of magnetic force provided by said means for providing magnetic field and said material attractively reactive to magnetic field.

10. A method of connecting a means for holding to a surface as set forth in claim 9 wherein said predetermined body including material attractively reactive to magnetic field being a metal stand base thereby said eleventh means for holding with said means for providing magnetic field to be securely connected to said metal stand base by means of magnetic force provided by said means for providing magnetic field and said metal stand base.

11. A method of connecting a means for holding to a surface providing
a means for providing magnetic field
a twelfth means for holding including material attractively reactive to magnetic field
a predetermined body
whereby said means for providing magnetic field included in said predetermined body thereby said twelfth means for holding including material attractively reactive to magnetic field to be securely connected to said predetermined body including said means for providing magnetic field by means of magnetic force provided by said means for providing magnetic field and said material attractively reactive to magnetic field.

12. A method of connecting a means for holding to a surface as set forth in claim 9 wherein said predetermined body being a stand base with said means for providing magnetic field thereby said twelfth means for holding to be securely connected to said stand base with said means for providing magnetic field by means of magnetic force provided by said means for providing magnetic field and said twelfth means for holding.
